(19) United States
(12) Patent Application Publication
(10) Pub. No.: US 2009/0309504 A1
(43) Pub. Date: Dec. 17, 2009

(54) COLOR-CONTROLLABLE LIGHT STRING

(76) Inventor: Sheng Hsu, Kaohsiung Hsien (TW)

Correspondence Address: Hershkovitz & Associates, LLC, 2845 Duke Street, Alexandria, VA, 22314, US

(21) Appl. No.: 12/139,287

(22) Filed: Jun. 13, 2008

(51) Int. Cl. H05B 37/02

(52) U.S. Cl. 315/185 S

(57) ABSTRACT

A color-controllable light string has a control box and a light string composed of lighting units. The control box provides a DC power to the lighting units through two power wires and transmits a synchronization signal to the lighting units through a signal wire. Each of the lighting units has a waterproof assembly constructing a sealed environment and an LED circuit board with multiple LEDs of different colors mounted in the sealed environment to provide colorful lights by mixing and activating proper LEDs.

### BACKGROUND OF THE INVENTION

1. Field of the Invention

The present invention relates to a color-controllable light string, and more particularly to a color-controllable light string with waterproof structures.

2. Description of Related Art

Conventional decorative light strings typically consist of multiple lighting units being connected to a power cable. All the lighting units have the same single color and are controlled by a circuit to turn on or off in accordance with a predetermined simple fashion. Since these lighting units only provide limited decorative effects, end-users may easily lose interest in the decorative light strings. Furthermore, the absence of the protecting structures in the lighting units makes the decorative light string easily damaged or broken.

To overcome the shortcomings the present invention provides a color-controllable light string to mitigate or obviate the aforementioned problems.

### SUMMARY OF THE INVENTION

The main objective of the present invention is to provide a color-controllable light string capable of emitting lights of different colors under the control of a control box and providing a waterproof sealed environment for lighting elements.

To achieve objective, the color-controllable light string comprises a control box a light string.

The control box is connected to a plug to receive an AC power, converts the AC power to a DC power, generates a synchronization signal, and has a main control board to which a first power wire, a second power wire and a signal wire are connected.

The light string is connected to the control box and comprises multiple lighting units connected in sequence. Each of the multiple lighting units has an LED circuit board mounted with multiple LEDs of different colors and a waterproof assembly proving a sealed environment for holding the LED circuit board.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a color-controllable light string in accordance with the present invention;

FIG. 2 is an exploded perspective view of the color-controllable light string in accordance with the present invention;

FIG. 3 is a circuit diagram of a control box used in the color-controllable light string in accordance with the present invention; and

FIGS. 4A and 4B show an equivalent circuit diagram of the color-controllable light string in accordance with the present invention.

### DETAILED DESCRIPTION OF THE PREFERRED EMBODIMENT

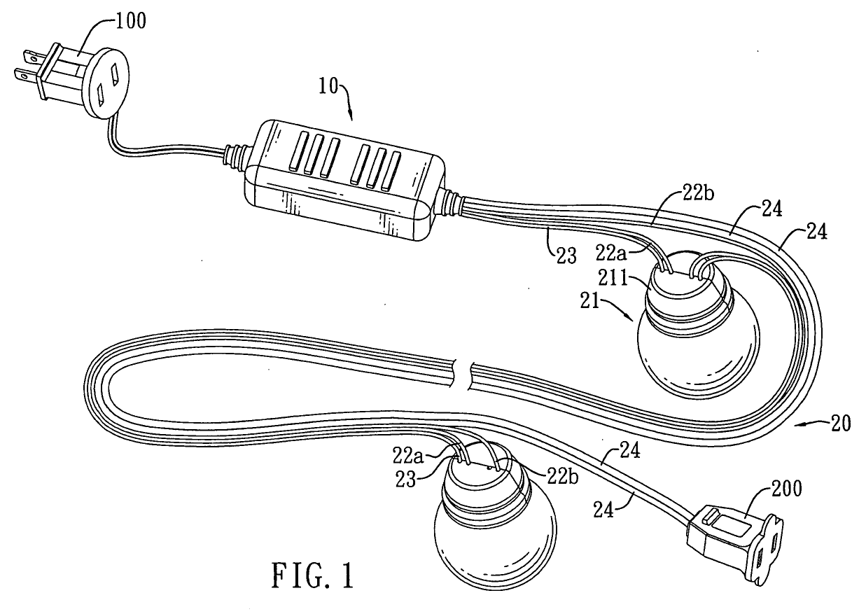

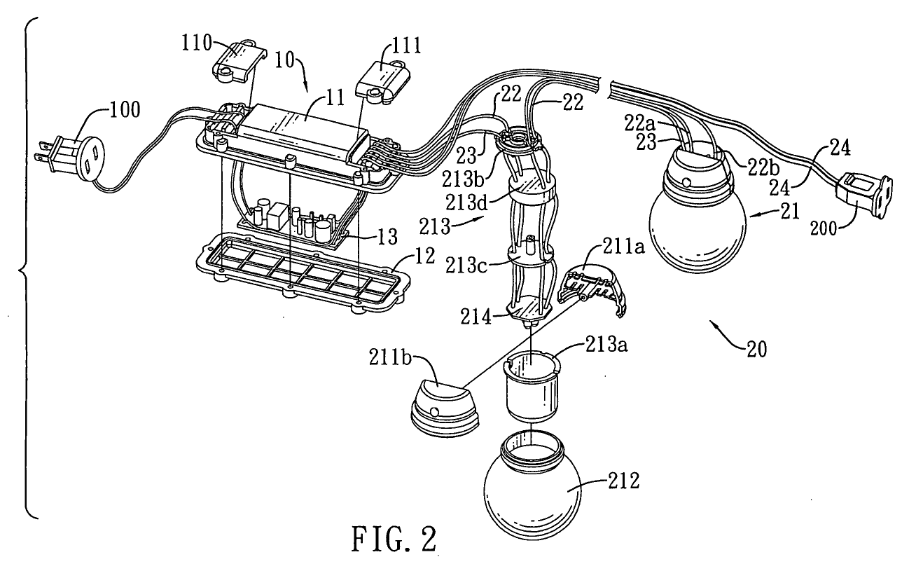

With reference to FIGS. 1 and 2, a color-controllable light string in accordance with the present invention comprises a control box (10) and a light string (20).

The control box (10) connects to a plug (100) being connected to a power source. Preferably, the power source is an AC power source. The control box (10) includes a top cover (11), a bottom plate (12) and a main control board (13). The top cover (11) is mounted on the bottom plate (12) and may further have a front protecting cover (110) and a rear protecting cover (111) being detachably mounted on the bottom plate (12). The main control board (13) is fixed on the bottom plate (12) and mounted between the top cover (11) and the bottom plate (12).

The light string (20) is connected to the control box (10) and comprises multiple lighting units (21), a first power wire (22a), a second power wire (22b) and a signal wire (23). Each of the lighting units (21) has a base (211), a bulb (212), a waterproof assembly (213) and a LED circuit board (214) with multiple light emitting diodes of different colors.

The base (211) may be constructed of two parts, i.e. a male half base (211a) and a female half base (211b) being correspondingly mounted together.

The bulb (212) has a chamber and is mounted on the base (211).

The waterproof assembly (213) includes a cap (213a) with an opening, a first plate (213b), a second plate (213c) and a stopper (213d). The cap (213a) is previous to the light, attached to the base (211) and mounted in the bulb (212) and holds the LED circuit board (214) therein.

The second plate (213c) has a protrusion that extends into the stopper (213d). The stopper (213d) is configured between the first plate (213b) and the second plate (213c). The first plate (213b) is mounted on the opening of the cap (213a).

The first power wire (22a) extending from the control box (10) electrically and sequentially connects to the LED circuit boards (214) of the lighting units (21) and protrudes through the waterproof assemblies (213).

The second power wire (22b) from the control box (10) extends through the base (211) and the waterproof assembly (213) to connect to the LED circuit board (214) of the last lighting unit (21).

The signal wire (23) extending from the control box (10) is connected to all LED circuit boards (214) sequentially through the bases (211) and waterproof assemblies (213) of all lighting units (21).

The light string (20) may further comprise a power extension cord (24) connecting to the main control board (13) in the control box (10) and provided with a socket (200) for further correspondingly connecting to a plug (100) of another color-controllable light string to lengthen the light string.

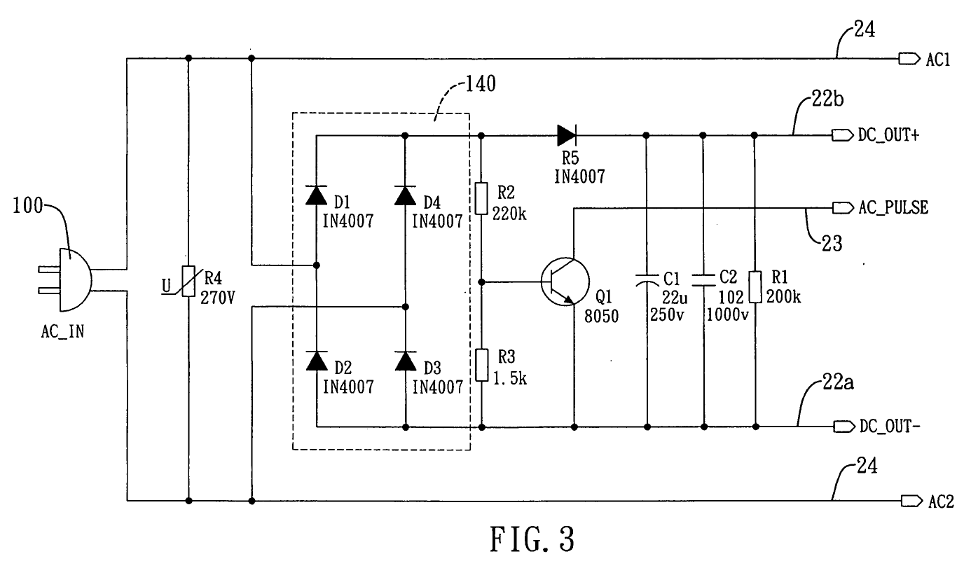

With further reference to FIG. 3, the main control board (13) in the control box (10) comprises a rectifying unit (140) and a transistor (141).

The rectifying unit (140) is connected to the plug (100) to convert an AC power to a DC power being output to DC output terminals (DC_OUT+) (DC_OUT−) through two resistors (R2)(R3) in series, capacitors (C1)(C2) and a resistor (R1).

The transistor (141) has a base, a collector and an emitter. The base is connected to the resistor (R3) and the emitter is connected to one of the DC output terminals (DC_OUT−). The collector outputs a frequency-multiplied AC synchronization signal to the LED circuit board (241) in the first light unit (21) being directly connected to the control box (10).

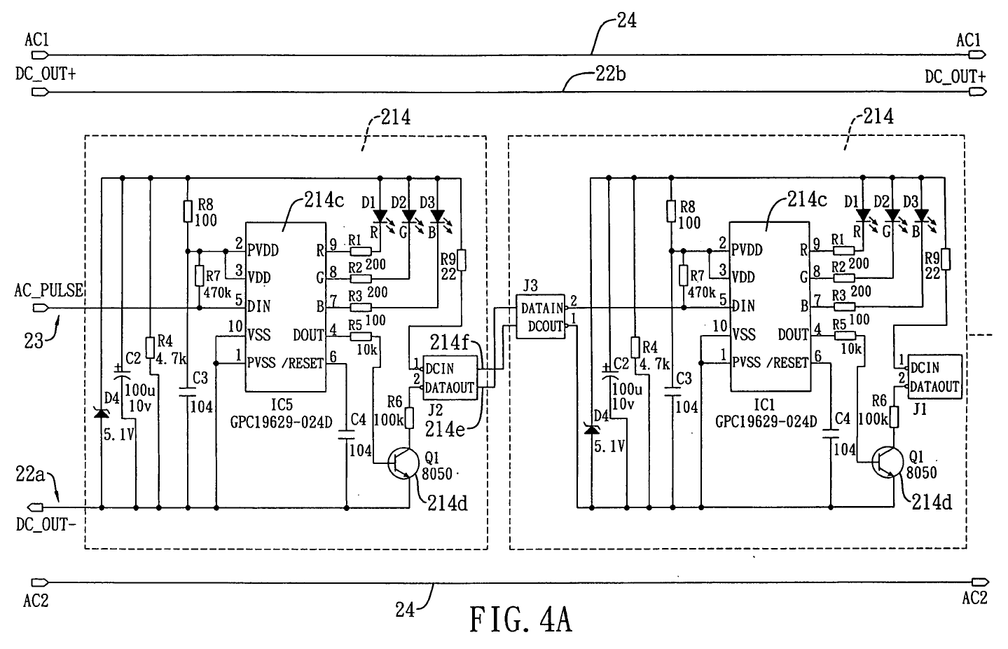

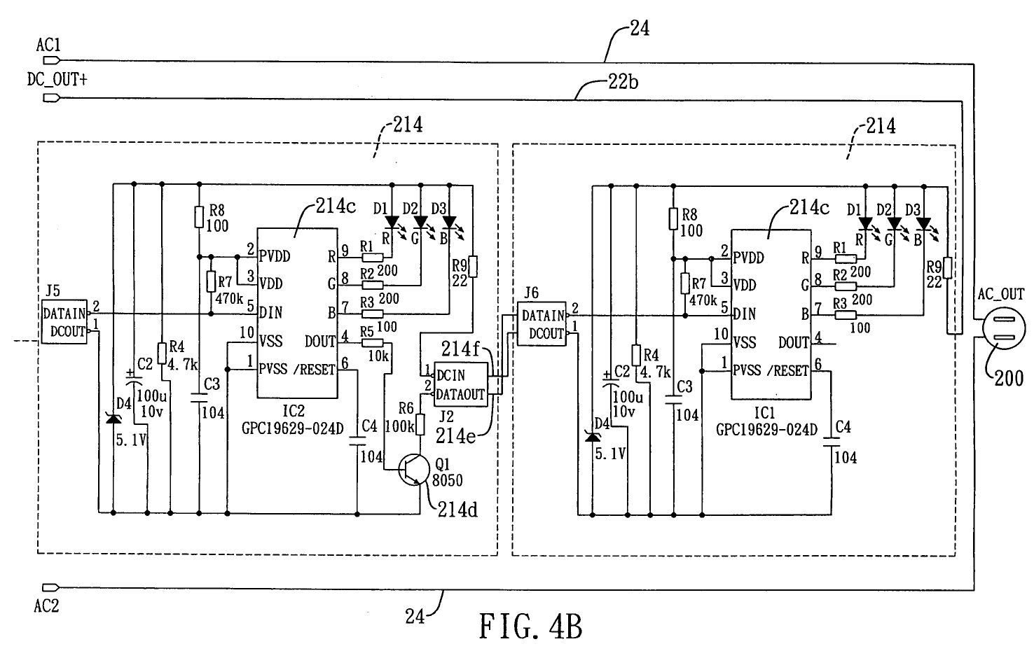

With reference to FIGS. 4A and 4B, the LED circuit boards (214) of the lighting units (21) are sequentially connected.

Each LED circuit board (214) has a controller (214c), a transistor (214d), multiple LEDs (D1)(D2)(D3) and a connector with a DC input terminal (214f) and a data output terminal (214e).

The controller (214c) may be the integrated circuit GPC19629-094D with a data input pin (DIN), a data output pin (DOUT), multiple control pins (R)(G)(B) and positive voltage pins (VDD)(PVDD). The data input pin (DIN) receives the synchronization signal from the control box (10) or a previous lighting unit (20) through the signal wire (23). In detail, the data input pin (DIN) of the first lighting unit (20) is connected to the collector of the transistor (141) in the control box (10). For each of other subsequent lighting units (21), the data input pin (DIN) is connected to the data output terminal (214e) of the previous lighting unit (21).

The DC output terminal (DC_OUT+) is firstly connected to the LED circuit board (214) of the last lighting unit (21) to provide the DC power. The DC power will transmitted sequentially from the last lighting unit (21) to the previous lighting units (21) through the DC input terminal (214f), and received by the positive voltage pins (VDD)(PVDD) of the controller (214c).

The multiple LEDs (D1)(D2)(D3) of different colors are connected to control pins (R)(G)(B) of the controller (214c) and can be respectively activated to generate a desired color by selecting proper LEDs and mixing the lights of the activated LEDs. In this embodiment, the LEDs (D1)(D2)(D3) include red, green and blue LEDs.

When the first lighting unit (21) receives the frequency-multiplied AC synchronization signal from the control box (10), the AC synchronization signal will sequentially transmit to the lighting units (21). Based on to the AC synchronization signal, the controllers (214c) can activate the LEDs (D1)(D2)(D3) at the same time. Furthermore, the controllers (214c) may repeatedly receive the AC synchronization signal to maintain synchronized operations. According to the control programs preset in each controller (214c), the red, green and blue LEDs (D1)(D2)(D3) can be selectively turned on or turned off to generate colorful light.

Further, the waterproof assembly with two plates and a stopper mounted together attaches to the cap to construct a sealed environment. Therefore, the LED circuit board and the LEDs can obtain superior protection.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A color-controllable light string comprising:
a control box connected to a plug to receive an AC power, converting the AC power to a DC power, generating a synchronization signal, and having a main control board to which a first power wire, a second power wire and a signal wire are connected for transmitting the DC power and the synchronization signal; and
a light string connected to the control box and comprising multiple lighting units connected in sequence, each of the multiple lighting units having:
an LED circuit board mounted with multiple LEDs of different colors and connecting to the first power wire, the second power wire and the signal wire to receive the DC power and the synchronization signal; and
a waterproof assembly proving a sealed environment for holding the LED circuit board.

2. The color-controllable light string as claimed in claim 1, wherein each of the multiple lighting units further has
a base;
a bulb having a chamber and mounted to the base; and
the waterproof assembly being mounted in the chamber.

3. The color-controllable light string as claimed in claim 1, wherein the waterproof assembly has a cap, a first plate, a second plate and a stopper;
the cap having an opening and allowing the LED circuit board to be mounted in the cap;
the stopper being configured between the first plate and the second plate and retained in the cap;
the second plate having a protrusion extending into and combined with the stopper and being retained in the cap; and
the first plate being mounted on the opening of the cap.

4. The color-controllable light string as claimed in claim 2, wherein the waterproof assembly has a cap, a first plate, a second plate and a stopper;
the cap having an opening and allowing the LED circuit board to be mounted in the cap;
the stopper being configured between the first plate and the second plate and retained in the cap;
the second plate having a protrusion extending into and combined with the stopper and being retained in the cap; and
the first plate being mounted on the opening of the cap.

5. The color-controllable light string as claimed in claim 1, wherein the control box further connects to a power extension cord with a socket for further correspondingly connecting to another color-controllable light string.

6. The color-controllable light string as claimed in claim 2, wherein the control box further connects to a power extension cord with a socket for further correspondingly connecting to another color-controllable light string.

7. The color-controllable light string as claimed in claim 3, wherein the control box further connects to a power extension cord with a socket for further correspondingly connecting to another color-controllable light string.

8. The color-controllable light string as claimed in claim 4, wherein the control box further connects to a power extension cord with a socket for further correspondingly connecting to another color-controllable light string.

9. The color-controllable light string as claimed in claim 5, wherein the main circuit board of the control box comprises:
a rectifying circuit for converting the AC power received from the plug to the DC power being output through the first power wire and the second power wire;
two resistors connected in series between the first power wire and the second power wire; and
a transistor has a base, a collector and an emitter, the base being connected to the two resistors, the emitter being connected to the first power wire, and the collector being used to output the synchronization signal.

10. The color-controllable light string as claimed in claim 6, wherein the main circuit board of the control box comprises:
a rectifying circuit for converting the AC power received from the plug to the DC power being output through the first power wire and the second power wire;
two resistors connected in series between the first power wire and the second power wire; and
a transistor has a base, a collector and an emitter, the base being connected to the two resistors, the emitter being connected to the first power wire, and the collector being used to output the synchronization signal.

11. The color-controllable light string as claimed in claim 7, wherein the main circuit board of the control box comprises:
a rectifying circuit for converting the AC power received from the plug to the DC power being output through the first power wire and the second power wire;
two resistors connected in series between the first power wire and the second power wire; and
a transistor has a base, a collector and an emitter, the base being connected to the two resistors, the emitter being connected to the first power wire, and the collector being used to output the synchronization signal.

12. The color-controllable light string as claimed in claim 8, wherein the main circuit board of the control box comprises:
a rectifying circuit for converting the AC power received from the plug to the DC power being output through the first power wire and the second power wire;
two resistors connected in series between the first power wire and the second power wire; and
a transistor has a base, a collector and an emitter, the base being connected to the two resistors, the emitter being connected to the first power wire, and the collector being used to output the synchronization signal.

13. The color-controllable light string as claimed in 9, wherein the LED circuit board comprises:
a controller with a data input pin (DIN), a data output pin (DOUT), multiple control pins and positive voltage pins;
the data input pin receiving the synchronization signal from either the control box or the LED circuit board of a previous lighting unit;
the data output pin outputting the synchronization signal to the LED circuit board of a subsequent lighting unit through a transistor;
the multiple control pins respectively connected to the multiple LEDs of the different colors; and
the positive voltage pins of the LED circuit board of the last lighting unit in the color-controllable light string being connected to the second power wire to receive the DC power, and the DC power being transmitted to the positive voltage pins of other previous LED circuit boards sequentially.

14. The color-controllable light string as claimed in 10, wherein the LED circuit board comprises:
a controller with a data input pin (DIN), a data output pin (DOUT), multiple control pins and positive voltage pins;
the data input pin receiving the synchronization signal from either the control box or the LED circuit board of a previous lighting unit;
the data output pin outputting the synchronization signal to the LED circuit board of a subsequent lighting unit through a transistor;
the multiple control pins respectively connected to the multiple LEDs of the different colors; and
the positive voltage pins of the LED circuit board of the last lighting unit in the color-controllable light string being connected to the second power wire to receive the DC power, and the DC power being transmitted to the positive voltage pins of other previous LED circuit boards sequentially.

15. The color-controllable light string as claimed in 11, wherein the LED circuit board comprises:
a controller with a data input pin (DIN), a data output pin (DOUT), multiple control pins and positive voltage pins;
the data input pin receiving the synchronization signal from either the control box or the LED circuit board of a previous lighting unit;
the data output pin outputting the synchronization signal to the LED circuit board of a subsequent lighting unit through a transistor;
the multiple control pins respectively connected to the multiple LEDs of the different colors; and
the positive voltage pins of the LED circuit board of the last lighting unit in the color-controllable light string being connected to the second power wire to receive the DC power, and the DC power being transmitted to the positive voltage pins of other previous LED circuit boards sequentially.

16. The color-controllable light string as claimed in 12, wherein the LED circuit board comprises:
a controller with a data input pin (DIN), a data output pin (DOUT), multiple control pins and positive voltage pins;
the data input pin receiving the synchronization signal from either the control box or the LED circuit board of a previous lighting unit;
the data output pin outputting the synchronization signal to the LED circuit board of a subsequent lighting unit through a transistor;
the multiple control pins respectively connected to the multiple LEDs of the different colors; and
the positive voltage pins of the LED circuit board of the last lighting unit in the color-controllable light string being connected to the second power wire to receive the DC power, and the DC power being transmitted to the positive voltage pins of other previous LED circuit boards sequentially.
